(19) United States
(12) Patent Application Publication
(10) Pub. No.: US 2023/0292748 A1
(43) Pub. Date: Sep. 21, 2023

(54) AGRICULTURAL FORMULATIONS HAVING IMPROVED COMPATIBILITY WITH LIQUID FERTILIZERS

(71) Applicant: SYNGENTA CROP PROTECTION AG, Basel (CH)

(72) Inventors: Eric Stephen OSHIGE, Greensboro, NC (US); Jinsong LEE, Greensboro, NC (US)

(73) Assignee: SYNGENTA CROP PROTECTION AG, Basel (CH)

(21) Appl. No.: 18/040,470

(22) PCT Filed: Aug. 5, 2021
(86) PCT No.: PCT/EP2021/071858

§ 371 Date: Feb. 3, 2023

(30) Foreign Application Priority Data
Aug. 5, 2020 (EP) 20189590.1

(51) Int. Cl. A01N 25/30; A01N 25/04; A01N 31/02; A01N 43/40; A01P 17/00; A01P 3/00; A01N 43/80; A01N 53/00; A01N 43/90; A01N 43/88; A01N 43/54; C05G 5/27; C05G 3/60

(52) U.S. Cl. CPC A01N 25/30; A01N 25/04; A01N 31/02; A01N 43/40; A01P 17/00; A01P 3/00; A01N 43/80; A01N 53/00; A01N 43/90; A01N 43/88; A01N 43/54; C05G 5/27; C05G 3/60

(57) ABSTRACT

The present invention relates to agricultural formulations having improved compatibility with liquid fertilizers comprising (i) a fertilizer compability agent, such as a phosphate ester, and (ii) a chelating agent.

### TECHNICAL FIELD

The present invention relates to agricultural formulations having improved compatibility with liquid fertilizers.

### BACKGROUND

Liquid fertilizers as used herein are any water-based compositions comprising nutrients which enhance the growth of plants. Nutrients are typically distinguished in main macronutrients [nitrogen (leaf growth), phosphorus (development of roots, flowers, seeds, fruit), potassium (strong stem growth, movement of water in plants, promotion of flowering and fruiting], secondary macronutrients [calcium, magnesium and sulfur] and micronutrients [copper, iron, manganese, molybdenum, zinc, boron]. There are many different sort of liquid fertilizers, e.g. liquid fertilizers comprising only the main macronutrients N, P and K [which are typically classified as NP, NK, PK or NPK fertilizers depending on their composition] or only micronutrients or both. The composition of liquid fertilizer may vary widely as they may be targeted to specific crops.

In order to save time, labor and energy, it has become common practice to mix such liquid fertilizers with agricultural formulations in a so-called tank mixing process and then directly applying the mixture onto the crops without addition of any additional water. Agricultural formulations are generally in form of liquid concentrates with relatively high amounts of pesticidal active ingredients, e.g. suspension concentrates (SC) or emulsifiable concentrates (EC), or as solid granules, e.g. water dispersible granules (WG) and water soluble granules (SG). When agricultural formulations are dispersed in liquid fertilizers during the tank mixing process, they tend to flocculate or oil out immediately. Some fertilizer compatibility agents have been developed to be built into agricultural formulations or to be added during the tank mixing process. The purpose of these fertilizer compatibility agents is to make agricultural formulations more compatible with liquid fertilizers. The most commonly used fertilizer compatibility agents on the market as post-addition during tank mix application or as built-in agents are phosphate esters and APGs (alkyl polyglucosides). However, these fertilizer compatibility agents have exhibited limited versatility when farmers have choices of not only a wide variety of liquid fertilizers on the market, but also custom blends of fertilizers or micronutrients for targeted crops. Generally, fertilizer compatibility agents do not work well with all active ingredients and types of agricultural formulations. Unless an agricultural formulation is specifically formulated to be electrolyte tolerant, the concentrated agricultural formulations will flocculate or oil out immediately when dispersed into a liquid fertilizer.

Hence, there is a strong need for agricultural formulations having improved compatibility with liquid fertilizers.

### DESCRIPTION OF THE EMBODIMENTS

Agricultural formulations are generally commercialized either as liquid concentrates with relatively high concentrations of active ingredient(s) or as solid granules or powders. Typical liquid agricultural formulations include but are not limited to:
Suspension concentrate (SC)
Flowable concentrate for seed treatment (FS)
Capsule suspension (CS)
Emulsifiable concentrate (EC)
Microemulsion (ME)
Suspoemulsion (SE)
Dispersible concentrate (DC)
Soluble concentrate (SL).

Typical solid agricultural formulations include but are limited to:
Water dispersible granules (WG)
Water soluble granules (SG)
Water soluble powder (SP).

It is common practice when applying both liquid or solid agricultural formulations to disperse the agricultural formulations directly in the liquid fertilizer without the addition of any additional water. Liquid fertilizers (generally aqueous fertilizers) are high electrolyte solutions with high ionic strength. The ionic strength depends on the concentration and the charges of the ions in the liquid fertilizer. Due to this, it is difficult to disperse agricultural formulations in liquid fertilizers. Generally, agricultural formulations will flocculate or oil out or show another adverse effect upon dispersion in liquid fertilizers. This is important because such mixtures of agricultural formulations with liquid fertilizers will be applied as spray mixtures using common spray equipment. For example, flocculation of agricultural formulations will lead to the blockage of spray nozzles and pipes. This means that in real life agricultural formulations with such failures cannot be applied commercially directly with liquid fertilizers. This is a significant commercial drawback for such agricultural formulations. Hence, some agricultural formulations have so-called fertilizer compatibility agents built into the compositions (see Background section). However, many of those fertilizer compatibility agents do not have much versatility, i.e. it may work on one particular liquid fertilizer but not on others. Hence, there is a need for a solution to this problem which is more generally applicable when mixing agricultural formulations with liquid fertilizers before spraying.

It has now been surprisingly found that the combination of specific co-formulants leads to markedly improved compatibility of agricultural formulations with liquid fertilizers. It has surprisingly been found that the combination of a fertilizer compatibility agent, in particular a phosphate ester fertilizer compatibility agent, and a chelating agent leads to significantly improved compatibility of agricultural formulations with any type of liquid fertilizer. The presence of both, a fertilizer compatibility agent and a chelating agent, as built-in co-formulants in the agricultural formulation are important for improving the compatibility with liquid fertilizers. Hence, as embodiment 1, there is provided an agricultural formulation comprising
(i) a fertilizer compability agent, such as a phosphate ester, and
(ii) a chelating agent.

The term “fertilizer compatibility agent” as used herein includes any agent which is designed to make agricultural formulations more compatible with liquid fertilizers. Typical fertilizer compatibility agents include but are not limited to alkyl polyglucosides (APGs), phosphate esters, lignosulfonates and graft comb polymers. Preferred fertilizer compatibility agents are APGs and phosphate esters, in particular phosphate esters.

The term “agricultural formulation” as used herein includes both liquid and solid agricultural formulation. Examples of both are given above. Most common liquid agricultural formulations are SC and EC and most common solid agricultural formulations are WG and SG. “Agricultural formulations” usually comprise one or more pesticidally active ingredients including insecticides, fungicides, bactericides, herbicides, acaridcides, nematicides, anthelmintics and plant growth regulators. The agricultural formulation according to embodiment 1 is applicable for any type of pesticidally active ingredient.

The term “chelating agent” as used herein are compounds containing at least two heteroatoms selected from oxygen, nitrogen and sulfur and are capable of entrapping or sequestering one or more metal atom cations. Furthermore, the chelating agents to be used according to the present invention in the agricultural formulations are preferably in the unmetallated form, i.e. the chelating agents have no entrapped or sequestered metal atom cations

The chelating agents are also capable of forming acid addition salts and those having at least one acidic group are capable of forming salts with bases. Suitable salts with bases are metal salts, in particular alkali metal salts and alkaline earth metal salts such as sodium, potassium or magnesium salts. Thus, a “chelating agent” as used herein generally comprises a plurality of groups selected from carboxylic acid, hydroxyl, thiol, phosphoric acid and derivatives thereof such as salt derivatives.

Particularly suitable “chelating agents” according to the present invention are selected from aminopolycarboxylic acid chelating agents, aromatic carboxylic chelating agents, aliphatic carboxylic chelating agents, amino acid chelating agents, ether polycarboxylic acid chelating agents, phosphoric acid chelating agents, hydroxycarboxylic acid chelating agents and dimethylglyoxime. The chelating agents may be in the form of the acid or a salt.

Examples of aminopolycarboxylic acid chelating agents include N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA), cyclohexanediaminetetraacetic acid (CDTA), nitriloacetic acid (NTA), iminodiacetic acid (IDA), N-(2-hydroxyethyl)imionodiacetic acid (HIMDA), diethylenetriaminepentaacetic acid (DTPA), glycoletherdiaminetetraacetic acid (GEDTA), ethylenediaminedisuccinic acid (EDDS) and salts thereof.

Examples of aromatic or aliphatic carboxylic acid chelating agents to be used in the present invention include oxalic acid, succinic acid, pyruvic acid, salicylic acid, anthranilic acid, and salts, methyl esters and ethyl esters thereof.

Examples of amino acid chelating agents include glycine, serine, alanine, lysine, cystine, cysteine, ethionine, tyrosine, methionine, and salts and derivatives thereof.

Examples of ether polycarboxylic acid chelating agents include compounds represented by the following formula or similar, and salts (e.g. sodium salt) thereof:

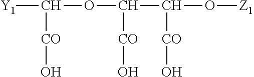

wherein Y₁ represents a hydrogen atom, —CH₂COOH or —COON, and Z₁ represents a hydrogen atom, —CH₂COOH or —CH₂(—CH₂COOH)COOH.

Examples of hydroxy carboxylic acid chelating agents include malic acid, citric acid, glycolic acid, gluconic acid, heptonic acid, tartaric acid, lactic acid and salts thereof.

Particularly suitable chelating agents to be used in the present invention are aminopolycarboxylic acid chelating agents. Thus, as embodiment 2, there is provided an agricultural formulation comprising
(i) a fertilizer compability agent, such as a phosphate ester, and
(ii) an aminopolycarboxylic acid chelating agent.

Particularly, as embodiment 3, there is provided an agricultural formulation comprising
(i) a fertilizer compability agent, such as a phosphate ester, and
(ii) an aminopolycarboxylic acid chelating agent, wherein
   the aminopolycarboxylic acid chelating agent is selected from N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA), cyclohexanediaminetetraacetic acid (CDTA), nitriloacetic acid (NTA), iminodiacetic acid (IDA), N-(2-hydroxyethyl)imionodiacetic acid (HIMDA), diethylenetriaminepentaacetic acid (DTPA), glycoletherdiaminetetraacetic acid (GEDTA), ethylenediaminedisuccinic acid (EDDS) and salts thereof. More particularly, the aminopolycarboxylic acid chelating agent is selected from N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA) and salts thereof. Even more particularly, the aminopolycarboxylic acid chelating agent is selected from N,N′-ethylene-bis(hydroxyphenyl)glycines (EDDHA), ethylenediaminetetraacetic acid (EDTA) and salts thereof. Most particularly, the aminopolycarboxylic acid chelating agent is ethylenediaminetetraacetic acid (EDTA) or a salt thereof, e.g. sodium salt.

The term “phosphate ester” as used herein includes any phosphate ester suitable for use in agricultural formulations. Particularly, it includes any phosphate ester which is known to be a fertilizer compatibility agent. The phosphate ester may be one type of phosphate ester or a mixture of phosphate esters. More particularly, the phosphate ester comprises phosphated C7-C12-alcohol alkoxylate, preferably phosphated C9-C11-alcohol alkoxylate, more preferably phosphated C7-C12 and C9-C11-branched alcohol alkoxylate. Even more particularly, the phosphate ester comprises at least one phosphated 2-propylheptanol alkoxylate. Hence, as embodiment 4, there is provided an agricultural formulation according to any of embodiments 1 to 3, wherein the phosphate ester comprises at least one phosphated C7-C12-alcohol alkoxylate, particularly C9-C11-alcohol alkoxylate, more particularly C7-C12 and C9-C11-branched alcohol alkoxylate, even more particularly phosphated 2-propylheptanol alkoxylate. In a further embodiment 5, the phosphate ester consists of one or more phosphated C7-C12-alcohol alkoxylate, particularly C9-C11-alcohol alkoxylate, more particularly phosphated 2-propylheptanol alkoxylate. Preferred phosphate esters are those phosphated 2-propylheptanol alkoxylates which comprise on average 1 to 20 ethoxy units and 0-3 propoxy units and/or butoxy units. More preferably, the phosphate ester is as disclosed in U.S. Pat. No. 8,937,033 B2 (see claims 11-15) and WO2019/162353. More preferably, as embodiment 6, the phosphate ester is selected from

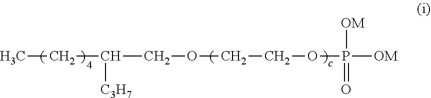

wherein M is selected from H, a monovalent metal ion and R¹R²R³R⁴N⁺, where R¹, R², R³ and R⁴ are selected from H, C1-C4 alkyl and —CH₂CH₂OH, and c is a number 1-20;

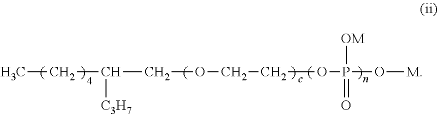

wherein n is a number 1-3, M is selected from H, a monovalent metal ion and R¹R²R³R⁴N⁺, where R¹, R², R³ and R⁴ are selected from H, C1-C4 alkyl and —CH₂CH₂OH, and c is a number 1-20; and
(iii) mixtures of (i) and (ii).

Even more preferably, as embodiment 7, the phosphate ester according to any one of embodiments 4-6 comprises 2 to 4 ethoxy units. Most preferably, as embodiment 8, the phosphate ester according to any one of embodiment 4-7 is a compound of

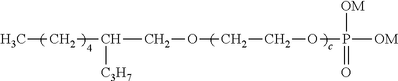

wherein M is selected from H, a monovalent metal ion and R¹R²R³R⁴N⁺, where R¹, R², R³ and R⁴ are selected from H, C1-C4 alkyl and —CH₂CH₂OH, and c is a number 2-4.

Phosphate esters according to any one of embodiments 4 to 8 are commercially available, for example under the tradename Agrilan™. The amount of phosphate ester according to any one of embodiments 4 to 8 built into an agricultural formulation varies according to the specific circumstances. However, if the agricultural formulation is a suspension concentrate (SC), then as embodiment 9, the amount of phosphate ester is typically between 5 and 20 weight % of the total agricultural formulation, particularly between 7.5 and 15 weight %, more particularly between 7.5 and 12.5 weight %.

Particularly, as embodiment 10, the agricultural formulation according to any one of embodiments 1 to 9 is selected from suspension concentrate (SC), oil in water emulsion (EW), water in oil emulsion (EO), suspoemulsion (SE), soluble liquid (SL), oil dispersion (OD), emulsifiable concentrate (EC), capsule suspension (CS), water dispersible granules (WG) and soluble granules (SG). More particularly, as embodiment 11, the agricultural formulation is selected from suspension concentrate (SC) and emulsifiable concentrate (EC). Even more particularly, as embodiment 12, the agricultural formulation is a suspension concentrate (SC).

The amount of chelating agent to be built into an agricultural formulation may vary depending on the type of agricultural formulation. A person skilled in the art is aware that a chelating agent needs to be soluble in an agricultural formulation in order to be able to act as a co-formulant. The chelating agent(s) generally have to be in solution in the agricultural formulation at the time when the agricultural formulation is dispersed into the liquid fertilizer. A skilled person is aware that the solubility of chelating agents may strongly vary from solvent to solvent and may also be pH dependent in aqueous agricultural formulation, i.e. a chelating agent may not be soluble at low pH but is soluble at high pH. An example for such a chelating agent whose solubility is pH dependent is for example EDTA which tends to form insoluble salts at lower pH. Such insoluble salts of a chelating agent may not only lead to the clogging of application equipment such as spray nozzles but also to a decrease in the ability of a chelating agent to act as a compatibility agent with liquid fertilizers.

As mentioned previously, the amount of chelating agent built into an agricultural formulation varies according to the specific circumstances. However, if the agricultural formulation is a suspension concentrate (SC), then as embodiment 13, the amount of chelating agent is typically between 1 and 10 weight % of the total agricultural formulation, particularly between 1 and 7.5 weight %, more particularly between 2 and 5 weight %. Furthermore, if the agricultural formulation is a SC, then the chelating agent is preferably an aminopolycarboxylic acid chelating agent, more preferably the chelating agent is selected from EDDHA and EDTA, or a salt thereof, even more preferably EDTA, or a salt thereof.

As mentioned previously, the solubility of chelating agent in aqueous agricultural formulations may be pH dependent. For example, if the chelating agent is EDTA, or a salt thereof, then a preferred pH range is between 6 and 9, more preferably the pH range is between 7 and 8.

The agricultural formulation according to any one of embodiments 1 to 13 generally comprises further co-formulants. One particular co-formulant commonly used are rheology modifiers or thickeners in order to improve the flowability of an agricultural formulation. It has unexpectedly been found that specific types of rheology modifiers are particularly suitable for agricultural formulations according to any one of embodiments 1 to 13. Hence, as embodiment 14, there is provided an agricultural formulation according to any one of embodiments 1 to 13, further comprising a non-organic rheology modifier. A “non-organic rheology modifier” as used herein means a rheology modifier which is not an organic macromolecule such as polysaccharides, i.e. starches, vegetable gums, pectin, or proteins. Typical examples of organic rheology modifiers include but are not limited to alginin, guar gum, locust bean gum, xantham gum, collagen, gelatin. As embodiment 15, preferred non-organic rheology modifiers are silicate based rheology modifiers, more preferably clay based rheology modifiers. Examples of commercially available clay based rheology modifiers include but are not limited to Attaflow FL™ and Volclay™. A person skilled in the art understands that the amount of non-organic rheology modifier depends on the particular circumstances and the technical requirements. However, in case that the agricultural formulation is a SC, then as embodiment 16, the amount non-organic rheology modifier is between 0.1 and 5 weight % of the total agricultural formulation, in particular between 0.5 and 2.5 weight %.

Furthermore, agricultural formulations according to any one of embodiments 1 to 16 generally comprise additional co-formulants such as antifoam agents, antifreeze agents, binders, buffers, dispersing agents, wetting agents, dyes, emulsifiers, fillers, pigments, solvents. A person skilled in the art is aware that these co-formulants are employed according to the specific circumstances and needs. These co-formulants should not interfere with the function of the phosphate ester and chelating agent to improve the compatability of the agricultural formulations with liquid fertilizers.

As mentioned above, the agricultural formulations according to any one of embodiments 1 to 16 may be used for any pesticidally active ingredients including insecticides, fungicides, bactericides, herbicides, acaridcides, nematicides, anthelmintics and plant growth regulators. A person skilled in the art understands that an agricultural formulation must be adapted to the specific physical-chemical properties of the active ingredient(s) present. For example, the type of agricultural formulation to choose depends on the active ingredient(s) present.

As mentioned previously, SC formulations are advantageous in the present invention. Hence, as embodiment 17, there is provided a suspension concentrate agricultural formulation comprising
(i) 10 to 50 weight % of the total agricultural formulation of an active ingredient;
(ii) 5 to 20 weight % of the total agricultural formulation of a fertilizer compability agent, such as a phosphate ester;
(iii) 1 to 10 weight % of the total agricultural formulation of a chelating agent.

As embodiment 18, there is provided the SC formulation according to embodiment 17, comprising a rheology modifier according to any one of embodiment 14 to 16, particularly 0.1 and 5 weight % of the total agricultural formulation of a rheology modifier, more particularly between 0.5 and 2.5 weight % of the total agricultural formulation of a rheology modifier.

As embodiment 19, the phosphate ester in embodiment 17 is defined as in any one of embodiments 4 to 8. As embodiment 20, the chelating agent in embodiment 17 is defined as in embodiment 2 and 3. As embodiment 21, the phosphate ester in embodiment 17 is defined as in any one of embodiments 4 to 8 and the chelating agent in embodiment 17 is defined as in embodiment 2 and 3.

As embodiment 22, there is provided an SC formulation according to any one of embodiments 17 to 21, further comprising a tristyrylphenol surfactant, particularly a tristyrylphenol ethoxylate nonionic surfactant. In another preferred embodiment 23, there is provided an SC formulation according to any one of embodiments 17 to 22, further comprising 10 to 20 weight % of the total weight of the agricultural formulation of an antifreeze agent, particularly propylene glycol.

As embodiment 24, the active ingredients which are particularly suitable for being formulated into a SC formulation according to any one of embodiments 1 to 23 are selected from
Isocycloseram (ISO name),
Cyclobutrifluram (ISO name),
Bifenthrin (ISO name),
Fluopyram (ISO name),
Fluoxastrobin (ISO name), and
Azoxystrobin (ISO name).

As embodiment 25, there is here is provided an SC formulation according to any one of embodiments 1 to 24, wherein
(i) 20 to 30 weight % of the total agricultural formulation of an active ingredient;
(ii) 7.5 to 12 weight % of the total agricultural formulation of a fertilizer compability agent, such as a phosphate ester;
(iii) 2 to 5 weight % of the total agricultural formulation of a chelating agent;
(iv) 0.5 to 2.5 weight % of the total agricultural formulation of a rheology modifier.

As a preferred embodiment 26, there is provided the SC formulation according to embodiment 25, wherein the SC formulation comprises cyclobutrifluram. As embodiment 27, there is provided the SC formulation according to embodiment 26, wherein the pH is in the range between 7 and 8. As embodiment 28, there is provided a method of controlling damage and/or yield loss caused by a pest and/or fungi (particularly nematodes) which comprises applying to a pest, to a locus of a pest, or to a plant susceptible to attack by a pest and/or fungi or to a plant propagation material an effective amount of an agricultural formulation according to any one of embodiments 1 to 27, more particularly an SC formulation as defined in embodiments 26 or 27. As embodiment 29, there is provided a method for protecting plant propagation material from damage and/or yield loss caused by a pest and/or fungi (particularly nematodes) which comprises applying to the propagation material or the site, where the propagation material is planted, an effective amount of an agricultural formulation according to any one of embodiments 1 to 27, more particularly an SC formulation as defined in embodiments 26 or 27.

Typical applications of agricultural formulations according to any one of embodiments 1 to 27 are in-furrow, drench or drip applications.

The following Examples serve to illustrate the invention. They do not limit the invention in any way.

### Experimental

### Preparation of SC Formulations According to the Invention

TABLE 1
SC formulation tested.

| Component | w/w (%) |
|---|---|
| Active ingredient (cyclobutrifluram) | 26 |
| Naphthalene sulfonate condensate (wetting | 0-2 |
| agent for cyclobutrifluram) | |
| Antifreeze | 5.0-15.0 |
| Antifoam | 0.01-0.15 |
| Biocide | 0-0.20.0 |
| Phosphate ester | 0.1-30.0 |
| Tristyrylphenol ethoxylate nonionic emulsifier | 0.1-2.0 |
| Sodium Hydroxide, 30% | 1.8 |
| Chelating agent solution (aminopoly- | 0-35.0 |
| carboxylic acid chelating agent) | |
| Attapulgite or bentonite clay dispersion | 0.5-8.5 |
| Water | rest |
| TOTAL | 100 |

Formulations were prepared by milling the active ingredient in the presence of water and a wetting agent to the desired particle size. Typical particle sizes of the active ingredients depend on the type of active ingredient, but in general the range of particle sizes is between 1 nm-150 μm, typically between 1 nm-30 μm. To prepare the final suspension concentrate (SC), the milled active ingredient premix was added with stirring to the mixture of remaining components listed in Table 1. Stirring was continued until a homogenous mixture was achieved.

### Liquid Fertilizer Compatibility Testing

The following liquid fertilizers were investigated:

TABLE 2
List of liquid fertilizers investigated.

| ID code | N-P-K Fertilizers + micronutrients |
|---|---|
| A | 10-34-0 |
| B | 0-0-29 with 3 pt Mn per 3 gals |
| C | 0-0-29 with 3 pt Zn per 3 gals |
| D | 10-18-5-1S with 3 pt Zn + 3 pt Mn per 3 gals |
| E | 9-18-9-1s 0.1 Zn |
| F | 8-21-5 |
| G | SOL-U-GRO 12-48-8 |
| H | RISER 7-17-3 |
| I | 8-16-8 2% SULFUR STARTER/TRANSPLANT |
| | SOLUTION |
| J | 4-0-8 |
| K | 7-2-8 |
| L | 0-0-29 with 1 pt Zn+ 1 pt Mn per 5 gal |
| M | 8-18-4 0.1Cu 0.2Fe 0.5Mn 0.5 Zn |
| N | 10-18-4 |
| O | 8-24-3-1S GS GREEN 1 pt 9% Zn per 3 gal |

Primary fertilizers comprise NPK (Nitrogen, Phosphorous and Potassium); the number represents the content of each element in the liquid (generally aqueous) fertilizer. For example, 10-34-0 means 10% Nitrogen, 34% Phosphorus (P₂O₅), 0% Potassium (K₂O). Fertilizers A, F, J, K and N in Table 2 are such fertilizers. Fertilizers may also contain secondary nutrients (sulfur, calcium, magnesium) and micronutrients (boron (B), copper (Cu), iron (Fe), manganese (Mn), molybdenum (Mo), zinc (Zn), nickel (Ni) and chloride (Cl)). Some of the fertilizers in Table 2 contain secondary nutrients and micronutrients.

The following method was used to evaluate the tank mix compatibility:

A glass vessel was charged with the liquid fertilizer according to Table 2, followed by addition of the fertilizer-compatible formulation at the typical use rate. The mixture was agitated to simulate mixing in a spray tank and immediately passed through a sieve (50 mesh and 100 mesh). The sieve is given a visual and qualitative rating (either pass=P, marginal=M or fail=F) based on the amount of solid residue on the sieve. The mixture was then tested again after remaining standing for a longer period, for example after standing overnight.

The compatibility ratings were done according to the following categories:
Pass=P: No to minimal residues on the sieve; this was considered as fertilizer compatible.
Marginal=M: moderate residues on the sieve.
Fail=F: significant residues; this was considered as not being fertilizer compatible.

### Technical Effect of the Chelating Agent

Formulations according to Table 1 were prepared, with the only difference that half the formulations contained 3% of a chelating agent whereas the other half did not contain any chelating agent. All the formulations contained 11% by weight of phosphate ester. The formulations were then tank mixed with the liquid fertilizers according to Table 2 and then assessed as mentioned above. The results are shown in Table 3.

TABLE 3
Results from the fertilizer compatibility testing.

| Fertilizer ID code | A | | B | | C | | D | | E | | F | | G | | H | |
|---|---|---|---|---|---|---|---|---|---|---|---|---|---|---|---|---|
| Without chelating | P | M | F | F | F | F | P | P | P | P | P | P | P | P | P | P |
| agent | | | | | | | | | | | | | | | | |
| With chelating agent | P | P | P | P | P | P | P | P | P | P | P | P | P | P | P | P |
| (aminopolycarboxylic | | | | | | | | | | | | | | | | |
| acid chelating agent) | | | | | | | | | | | | | | | | |

| Fertilizer ID code | I | | J | | K | | L | | M | | N | | O | |
|---|---|---|---|---|---|---|---|---|---|---|---|---|---|---|
| Sieve mesh | 50 | 100 | 50 | 100 | 50 | 100 | 50 | 100 | 50 | 100 | 50 | 100 | 50 | 100 |
| Without chelating | P | P | P | P | P | F | F | F | P | P | P | P | P | P |
| agent | | | | | | | | | | | | | | |
| With chelating agent | P | P | P | P | P | P | P | P | P | P | P | P | P | P |
| (aminopolycarboxylic | | | | | | | | | | | | | | |
| acid chelating agent) | | | | | | | | | | | | | | |

Some samples were left standing for periods of time and then reassessed. The results can be found in Table 4.

TABLE 4
Results from the fertilizer compatibility testing after samples were
left standing for 4 and 8 hours, respectively.

| | | 5% Chelating agent | 5% Chelating agent |
|---|---|---|---|
| | No Chelating | (aminopolycarboxylic | (aminopolycarboxylic |
| | agent | acid chelating agent) | acid chelating agent) |
| Fertilizer | 0 hours | 4 hours | 24 hours |
| E | F | P | P |
| F | F | P | P |

### Examples of Cyclobutrifluram Formulations with Various Chelating Agent and Phosphate Ester Contents

The following Examples 1 to 8 of cyclobutrifluram formulations were tested for their compatibility with fertilizer 10-34-0 according to the method mentioned above. The results are shown in Table 4.

TABLE 4
Fertilizer compatibility with fertilizer 10-34-0.

| | Example | Example | Example | Example | Example | Example | Example |
|---|---|---|---|---|---|---|---|
| | 1 | 2 | 3 | 4 | 5 | 7 | 8 |
| | (% | (% | (% | (% | (% | (% | (% |
| Components | weight) | weight) | weight) | weight) | weight) | weight) | weight) |
| Cyclobutrifluram | 26 | 26 | 26 | 26 | 26 | 26 | 26 |
| Alkylnaphtalene sulfonate | 1 | 1 | 1 | 1 | 1 | 1 | 1 |
| condensate | | | | | | | |
| Tristyrylphenol ethoxylate | 0.7 | 0.7 | 0.7 | 0.7 | 0.7 | 0.7 | 0.7 |
| nonionic emulsifier | | | | | | | |
| Phosphated 2- | 11 | 11 | 8 | 0 | 11 | 11 | 11 |
| propylheptanol ethoxylate | | | | | | | |
| Chelating agent | 4 | 4 | 2 | 6 | 3 | 4 | — |
| (aminopolycarboxylic acid | | | | | | | |
| chelating agent) | | | | | | | |
| Propylene Glycol | 15 | 15 | 15 | 15 | 15 | 15 | 15 |
| Non-organic rheology | 7 | 7 | 8 | 8 | 7 | 6.2 | 5.5 |
| modifiers | | | | | | | |
| 10-34-0 Compatibility | Pass | Pass | Pass | Marginal | Pass | Pass | Pass |

### Examples of Formulations with Other Active Ingredients

Commercial formulations were tested for liquid fertilizer compatibility with and without the combination of phosphate ester and chelating agent.

| | Phosphate ester | | | |
|---|---|---|---|---|
| | (phosphated 2- | Chelating agent | | |
| | propylheptanol | (aminopolycarboxylic | Compatibility | |
| | ethoxylate) | acid chelating agent) | 50 | 100 |
| Formulation | (weight %) | (weight %) | mesh | mesh |
| Isocycloseram (200 gram/liter) SC (Syngenta) | 0 | 0 | F | P |
| Isocycloseram (200 gram/liter) SC (Syngenta) | | 3 | P | M |
| Bifenthrin (17.15 weight %; Capture LFR; FMC) | 0 | 0 | P | M |
| Bifenthrin (17.15 weight %; Capture LFR; FMC) | 11 | 3 | P | P |
| 22.20 weight % Imidacloprid and 15.4 weight % | 0 | 0 | F | F |
| Fluopyram (Velum Total; Bayer CropScience) | | | | |
| 22.20 weight % Imidacloprid and 15.4 weight % | 11 | 3 | M | M |
| Fluopyram (Velum Total; Bayer CropScience) | | | | |
| Fluoxastrobin (Tepera Fungicide; Arysta LifeScience) | 0 | 0 | P | P |
| Fluoxastrobin (Tepera Fungicide; Arysta LifeScience) | 11 | 3 | P | P |
| 22.9% (wt %) Azoxystrobin (Quadris; Syngenta) | 0 | 0 | F | M |
| 22.9% (wt %) Azoxystrobin (Quadris; Syngenta) | 11 | 3 | F | P |

1. An agricultural formulation comprising
(i) a fertilizer compatibility agent, and
(ii) a chelating agent.

2. An agricultural formulation according to claim 1, comprising
(i) a phosphate ester, and
(ii) a chelating agent.

3. The agricultural formulation according to claim 1, wherein the chelating agent is an aminopolycarboxylic acid chelating agent.

4. The agricultural formulation according to claim 1, wherein the chelating agent is ethylenediaminetetraacetic acid (EDTA) or a salt thereof,

5. The agricultural formulation according to claim 1, wherein the phosphate ester comprises at least one phosphated C7-C12-alcohol alkoxylate.

6. The agricultural formulation claim 1, wherein the phosphate ester comprises at least one phosphated 2-propylheptanol alkoxylate.

7. The agricultural formulation according to claim 1, wherein the agricultural formulation is a suspension concentrate.

8. The agricultural formulation according to claim 7, wherein the suspension concentrate comprises
(i) 10 to 50 weight % of the total agricultural formulation of an active ingredient;
(ii) 5 to 20 weight % of the total agricultural formulation of a fertilizer compability agent;
(iii) 1 to 10 weight % of the total agricultural formulation of a chelating agent.

9. The agricultural formulation according to claim 8, wherein the suspension concentrate comprises
(i) 20 to 30 weight % of the total agricultural formulation of an active ingredient;
(ii) 7.5 to 12 weight % of the total agricultural formulation of a fertilizer compability agent;
(iii) 2 to 5 weight % of the total agricultural formulation of a chelating agent;
(iv) 0.5 to 2.5 weight % of the total agricultural formulation of a rheology modifier.

10. The agricultural formulation according to claim 1, wherein the active ingredient is selected from
Isocycloseram (ISO name),
Cyclobutrifluram (ISO name),
Bifenthrin (ISO name),
Fluopyram (ISO name),
Fluoxastrobin (ISO name), and
Azoxystrobin (ISO name).

11. The agricultural formulation according to claim 1, further comprising 10 to 20 weight % of the total weight of the agricultural formulation of an antifreeze agent, particularly propylene glycol.

12. The agricultural formulation according to claim 6, wherein the agricultural formulation comprises cyclobutrifluram.

13. A method of controlling damage and/or yield loss caused by a pest and/or fungi which comprises applying to a pest or fungi, to a locus of a pest or fungi, or to a plant susceptible to attack by a pest and/or fungi or to a plant propagation material an effective amount of an agricultural formulation as defined in claim 1.

14. The method according to claim 13, wherein the agricultural formulation is applied in-furrow, drench or drip applications.

15. A method for protecting plant propagation material from damage and/or yield loss caused by a pest and/or fungi which comprises applying to the propagation material or the site, where the propagation material is planted, an effective amount of an agricultural formulation as defined in claim 1.
